(19) United States
(12) Patent Application Publication
(10) Pub. No.: US 2007/0197331 A1
(43) Pub. Date: Aug. 23, 2007

(54) Plate-link chain

(75) Inventors: Marcus Junig, Buhlertal (DE); Anton Simonov, Buhl (DE); Andreas Englisch, Buhl (DE); Olga Ispolatova, Buhl (DE); Michael Pichura, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/645,090

(22) Filed: Dec. 21, 2006

Related U.S. Application Data
(60) Provisional application No. 60/752,701, filed on Dec. 21, 2005.

(51) Int. Cl. F16G 13/04; F16G 5/16

(52) U.S. Cl. 474/215; 474/245; 474/213

(57) ABSTRACT

A plate-link chain, in particular a toothed plate-link chain, is composed of adjacent plates and opposing plates that form chain links by sets of the link plates. One or more spacer elements are installed between adjacent link plates to enable assembly of a wider chain at a reduced chain weight as compared with a chain in which additional link plate sets are installed to increase the chain width. The spacer elements have openings to receive hinge pins that pass through the link plates. The openings of the spacer elements can include pairs of openings, a single oblong opening, or openings that include gaps to enable assembly of a spacer element in a manner similar to a spring clip.

### BACKGROUND OF THE INVENTION

1. Field of the Invention

The present invention relates to a plate-link chain, in particular a toothed plate-link chain composed of plates and opposing plates that form chain links by sets.

2. Description of the Related Art

Such plate-link chains are known in the art. Examples thereof are DE 197 08 865 and the publications cited therein, EP 0 518 478, and EP 0 741 255. Such chains can be built up in connections of two plates or three plates.

From U.S. Pat. No. 1,020,180 a plate-link chain of modular construction is known, wherein a widening of the plate-link chain is accomplished by adding additional sets of plates. From U.S. Pat. No. 5,857,933 it is known to combine two plate-link chains to form one wider plate-link chain.

When plate-link chains are widened in accordance with the state of the art, additional plates or opposing plates are added to the sets of plates. While that results in greater tensile strength of the widened chain, it also increases the weight substantially.

An object of the present invention is to provide a plate-link chain that undergoes only a slight increase in weight when the plate-link chain is widened.

### SUMMARY OF THE INVENTION

That object is achieved by a plate-link chain, in particular a toothed plate-link chain, composed of plates and opposing plates that form chain links by sets, wherein at least a part of the chain links include at least one spacer element. Preferably, the plates are connected at both ends with the opposing plates by means of a hinged hinge, where the hinged hinges include a one piece or multiple-piece hinge pin that joins the plates and opposing plates with each other, and there is at least one spacer element is arranged on the hinge pins. Preferably there is provision that at least one spacer element is arranged on all hinge pins.

The plates, and/or the opposing plates, preferably have teeth so that the plate-link chain is a toothed plate-link chain. Preferably, there is provision that the hinge pin includes multiple parts and includes a rocker member that is associated with a plate that rolls with a roll section on a roll section of a rocker member that is associated with an opposing plate. Preferably, there is provision that the spacer element is positioned between two plates and/or between two opposing plates. The spacer element can also be positioned between a plate and an opposing plate. Preferably, there is provision that the spacer element is a spacer plate that is positioned between two hinge pins of a chain link. The chain links preferably have a guide plate on at least one side, with the spacer plate positioned between guide plates and plates, or between guide plates and opposing plates. A plurality of spacer plates can be arranged within a chain link. Preferably, there is provision that the spacer plate has an covering contour in the running plane of the chain that is smaller than the covering contour of the plates and/or opposing plates. Alternatively, it can be provided that the spacer plate has an covering contour in the running plane of the chain that is larger in the region of the teeth of the plates, and/or of the opposing plates, than the covering contour region of the teeth of the plates and/or of the opposing plates.

The spacer plate can have two bores, each of which receives a hinge pin. Alternatively, the spacer plate can have an opening that receives both hinge pins in the manner of an oblong hole. Preferably there is provision that the spacer plate has two openings, each with a gap that enables attachment of a spacer plate in the manner of a clip. Preferably it is provided that the gaps are positioned on the side of the plate-link chain opposite the teeth.

The object identified earlier is also achieved by a spacer element for use in a plate-link chain in accordance with the invention.

### BRIEF DESCRIPTION OF THE DRAWINGS

The structure, operation, and advantages of the present invention will become further apparent upon consideration of the following description, taken in conjunction with the accompanying drawings in which:

FIG. 1 is a side view of a portion of a known plate-link chain;

FIG. 2 is a top view of the plate-link chain shown in FIG. 1;

FIG. 3 is an end view of a first exemplary embodiment of a plate-link chain in accordance with the invention;

FIG. 4 is an end view of a second exemplary embodiment of a plate-link chain in accordance with the invention;

FIG. 5 is an end view of a third exemplary embodiment of a plate-link chain in accordance with the invention;

FIG. 6 is a top perspective view of the plate-link chain shown in FIG. 3;

FIG. 7a is a side view of a first exemplary embodiment of a spacer plate in accordance with the invention;

FIG. 7b is a side view of a chain including the spacer plate shown in FIG. 7a;

FIG. 8a is a side view of a second exemplary embodiment of a spacer plate in accordance with the invention;

FIG. 8b is a side view of a chain including the spacer plate shown in FIG. 8a;

FIG. 9a is a side view of a third exemplary embodiment of a spacer plate in accordance with the invention;

FIG. 9b is a side view of a chain including the spacer plate shown in FIG. 9a;

FIG. 10a is a side view of a fourth exemplary embodiment of a spacer plate in accordance with the invention;

FIG. 10b is a side view of a chain including the spacer plate shown in Figure FIGS. 10a; and

FIG. 11 is an enlarged side view of the chain area indicated by the designation XI in FIG. 10b.

### DESCRIPTION OF THE PREFERRED EMBODIMENTS

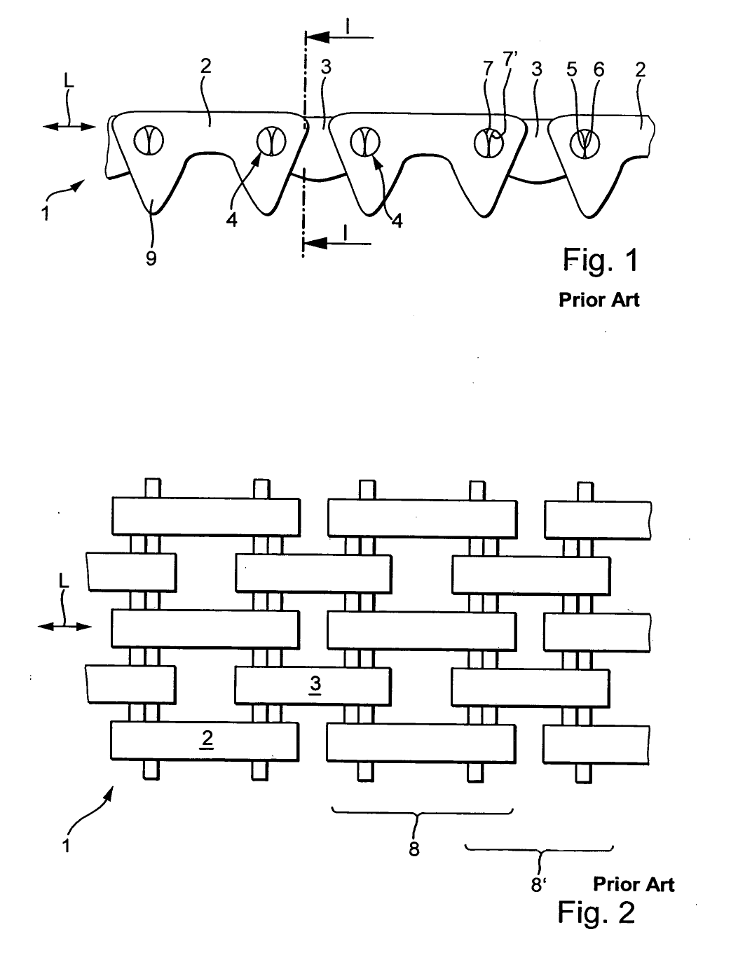

FIG. 1, by way of example, shows a side view, and FIG. 2 a top view of a plate-link chain in accordance with the state of the art, with a two-plate connection. The basic construction of plate-link chains and the terms used in the exemplary embodiments in accordance with the invention will be explained on the basis of FIGS. 1 and 2. The exemplary embodiments will be described using the example of a plate-link chain having a two-plate connection, but are equally applicable to a plate-link chain having a three-plate connection.

Plate-link chain 1 includes a large number of plates 2 and opposing plates 3. Plates 2 and opposing plates 3 are arranged alternately, and are combined as a hinge with hinge pins 4. Consequently, both ends of a plate are connected with one or two opposing plates by means of a hinge, and correspondingly both ends of an opposing plate are connected to one or two plates with a hinge. The hinge pins 4 can be a single piece, but are preferably in two pieces, with a rocker member 5 being associated with each of the plates 2 and that rolls on a rocker member 6 associated with the opposing plate 3. In addition, rocker members 5, 6 each have a roller profile 7 and 7′ respectively, with which they can roll or slide on each other. The roller profiles 7, 7′ can be identical or different. The plates 2 and opposing plates 3 are stacked transversely to the direction of running L, which is identified in FIGS. 1 and 2 by a double-headed arrow, so that an overlapping opposing plate is positioned between two hinge pins 4 that are arranged side-by-side perpendicular to the running direction L. Conversely, a plate is positioned between and overlaps two opposing plates that are side-by-side transversely in relation to the running direction. Of course, that does not apply to the plates 2 or opposing plates 3 that are located on the outside transversely to the running direction L, which have a neighboring plate on only one side. The sets of plates 2 constructed in that way form a chain link 8, and correspondingly, the sets of opposing plates 3 form a chain link 8′. The plates 2 and opposing plates 3 can be identical parts, a differentiation between plates 2 and opposing plates 3 being visible only from the arrangement. FIG. 2 shows a stack of three plates 2 and two opposing plates 3, wherein it is also possible to provide stacks with any other number of plates 2 and opposing plates 3.

As can be seen in FIG. 1, the plates 2 are each provided with teeth 9. With the teeth 9, plate-link chain 1 can mesh with a tooth arrangement, for example of a gear. The spacing between plates 2 and opposing plates 3 is designed so that when the chain is extended a uniform spacing results overall between the teeth 9. Alternatively, the opposing plates 3 can additionally be provided with teeth, so that all plates and opposing plates are provided with teeth. It is however equally possible to provide plates and opposing plates with only one tooth.

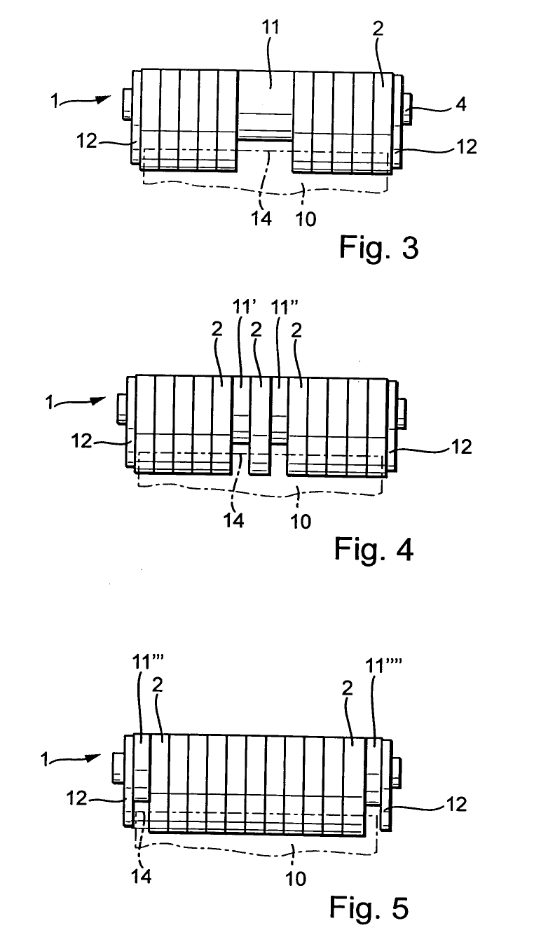

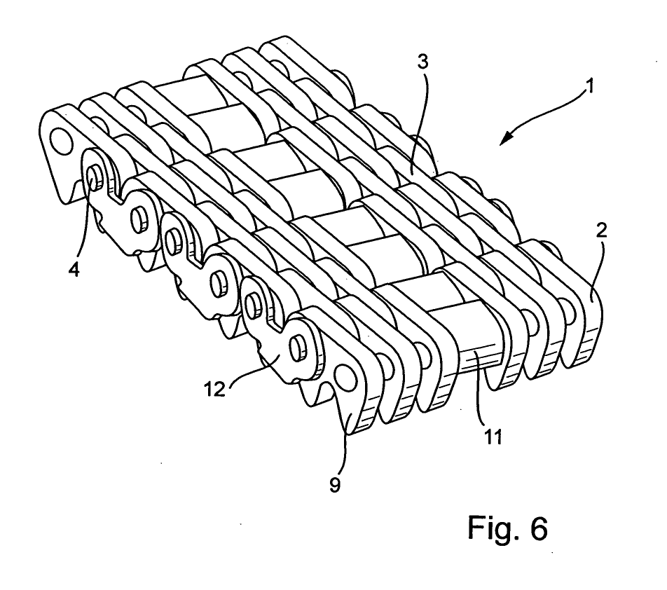

FIGS. 3 through 5 show embodiments of plate-link chains in accordance with the invention, each in cross section in a view taken in the direction of line I-I in FIG. 1, i.e., in a cross section through the plate-link chain 1, as shown, and viewed in the running direction L. In each case the illustration shows a plate-link chain 1 and a toothed wheel 10 with which the teeth 9 of the plate-link chain mesh. In FIG. 1, a single spacer plate 11 is positioned as a spacer element between two plates 2 or opposing plates 3. FIG. 6 shows the plate-link chain in accordance with FIG. 3 in a perspective view. As can be seen, spacer plates 11 are positioned between two plates 2, the plate sets being equally thick on both sides of spacer plates 11, which each include three of plates 2. The spacer plate is thus situated in a central position. Viewed in the running direction, in accordance with FIGS. 3 through 6, there are guide plates 12 positioned on both sides of the plate sets, which surround toothed wheel 10 and thus provide in a known way for guiding the plate-link chain 1 on toothed wheel 10 transversely to the running direction L.

FIG. 4 shows a further exemplary embodiment of a plate-link chain in accordance with the invention. Here two narrow spacer plates 11′ and 11″ are positioned between two plates 2. The spacer plates 11′ and 11″ can be positioned at any desired location within a chain link, and consequently of a plate set, and likewise, instead of two spacer plates a larger number of spacer plates can be provided.

FIG. 5 shows a third exemplary embodiment of a plate-link chain in accordance with the invention, where in each case a spacer plate 11′″ and 11″″ is positioned between a plate 2 and a guide plate 12.

Instead of between plates 2, the spacer plates 11 can also be positioned between opposing plates 3. It is equally possible—in particular with a three plate connection—to position the spacer plates 11 between plates 2 and opposing plates 3.

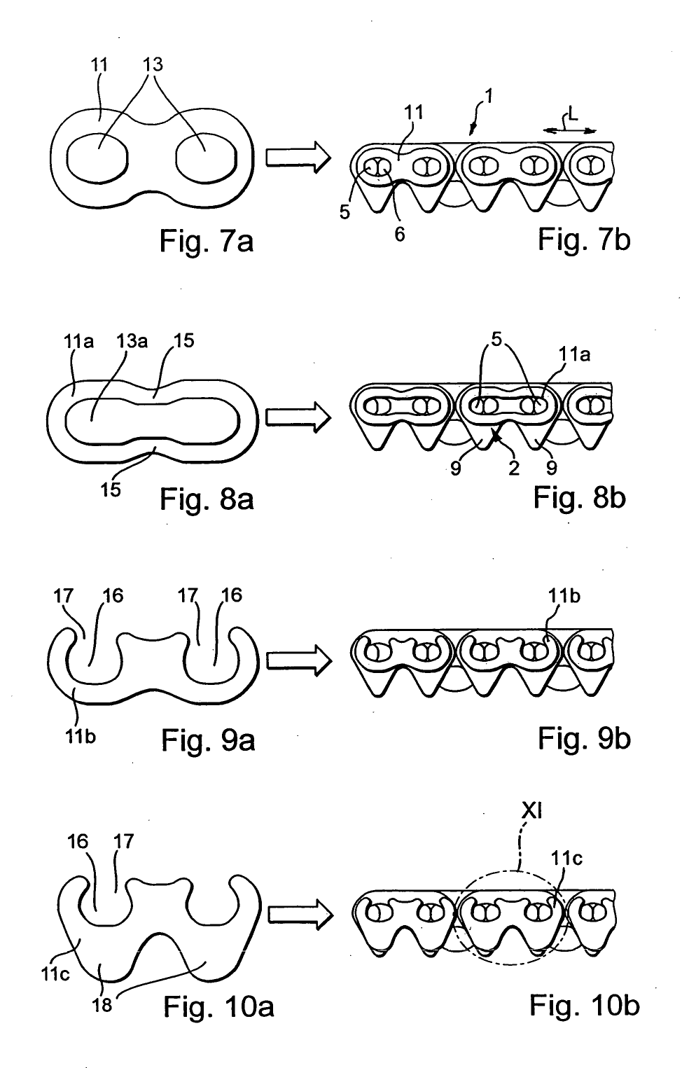

FIGS. 7a through 10b show exemplary embodiments of spacer plates 11 in profile or side views corresponding to the view in FIG. 1. Spacer plate 11 corresponds essentially to the cross section of a plate 2 without its teeth 9. Thus, spacer plate 11 in accordance with FIG. 7a does not reach into the teeth of toothed wheel 10 when the teeth 9 of plates 2 mesh, in particular on the side facing toothed wheel 10 in the installed position. That corresponds to the illustration in FIGS. 3 through 5. As can be seen from FIGS. 3 through 5, spacer plates 11 do not touch the upper edges of the tooth faces of toothed wheel 10 (shown as a dashed line 14). In FIG. 7b spacer plate 11 in accordance with FIG. 7a is shown in the installed position in a longitudinal section through plate-link chain 1 in the running direction L. Bores 13 are in contact with both rocker members 5, 6 and are thus held in position.

FIGS. 8a and 8b show an alternative configuration of a spacer plate 11, which is identified there with the reference numeral 11 a for easier differentiation. Instead of two bores 13, there a receiving opening 13a in the manner of an oblong hole is made. Thereby the spacer plate is only in contact with the two rocker members 5 that are associated with plate 2 having teeth 9, and hold spacer plate 11a in its position in the running direction L. In the side view in accordance with FIG. 8a, spacer plate 11a thus essentially has the form of a closed ring. Indentations 15 on both sides of spacer plate 11a create a greater distance from tooth face upper edge 14 in all four possible installation locations.

FIGS. 9a and 9b show a further exemplary embodiment of a spacer plate 11b in accordance with the invention. Instead of closed bores 13 as in FIG. 7a, here in each case an opening 16 is made which is provided with a gap 17 on the same side and thus embrace rocker members 5, 6 in the manner of a clip. That enables subsequent installation of spacer plates 11b in plate-link chain 1, in that plate-link chain 1 is first pre-installed with plates 2, opposing plates 3, rocker members 5, 6, and guide plates 12, with a space remaining between individual plates 2 or opposing plates 3. After the preliminary installation of plate-link chain 1, the spacer plates 11b can be installed subsequently, by pressing them onto rocker members 5, 6 in the manner of a clip with the help of the gaps 17.

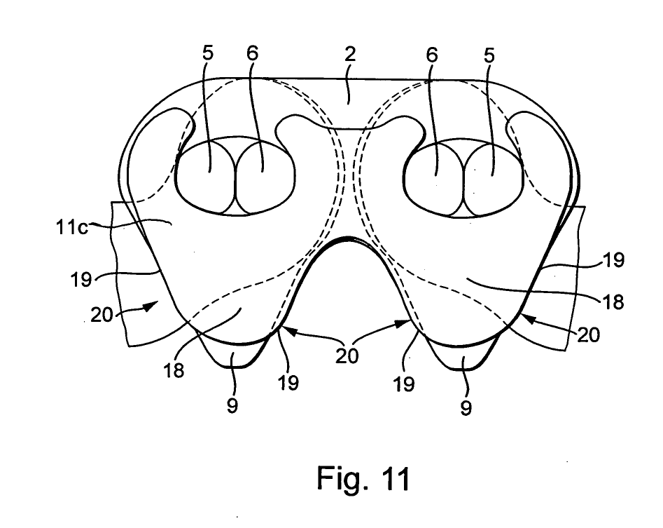

FIGS. 10a and 10b show a further alternative embodiment 11c of a spacer plate. Openings 16 and gaps 17 correspond to the embodiment in accordance with FIGS. 9a and 9b. In the embodiment in accordance with FIGS. 10a and 10b, there are teeth 18 situated on the sides of spacer plates 11c opposite gaps 17. The teeth can be designed so that with plate-link chain 1 in the installation position they are congruent with the teeth 9 of plates 2 in the running plane of the chain in the view in accordance with FIG. 10b, consequently transversely to the running direction L of plate-link chain 1. Alternatively, spacer plate teeth 18 in accordance with FIG. 11 can extend past the contour of teeth 9 at least in some regions, which is shown in FIG. 11 by arrows 20. Extending beyond means here that they project beyond the tooth face profile of teeth 9, so that the teeth 9 penetrate into the teeth of toothed wheel 10 as they mesh with toothed wheel 10, i.e., they overlap with the tooth face profile of toothed wheel 10. The covering contour of spacer plate 11c in the running plane of the chain is larger in the area of the teeth of the plates and/or of the opposing plates than the covering contour of the teeth of the plates and/or of the opposing plates themselves. The consequence of that, when plate-link chain 1 meshes with toothed wheel 10, is that the bulges 20 of the spacer plate teeth 18 become elastically deformed, which causes noise damping during the running of plate-link chain 1.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A plate-link chain comprising: a plurality of sets of first adjacent link plates and opposed link plates that together define chain links, wherein at least one of the chain links include at least one spacer element to increase chain width while minimizing an increase in chain weight.

2. A plate-link chain in accordance with claim 1, wherein the first plates are joined at both ends with opposed link plates by means of a hinge, wherein the hinge includes at least one hinge pin that joins first link plates and opposed link plates with each other, and that at least one spacer element is carried on the hinge pins.

3. A plate-link chain in accordance with claim 2, wherein at least one of the first link plates and the opposed link plates include teeth for engaging an externally toothed component.

4. A plate-link chain in accordance with claim 2, wherein the hinge pins are in multiple pieces and include a rocker member that is associated with a link plate and that rolls with a roller profile on a roller profile of a rocker member that is associated with an opposed link plate.

5. A plate-link chain in accordance with claim 1, wherein the spacer element is positioned between two first link plates.

6. A plate-link chain in accordance with claim 1, wherein the spacer element is positioned between two opposed link plates.

7. A plate-link chain in accordance with claim 1, wherein the spacer element is positioned between a first link plate and an opposed link plate.

8. A plate-link chain in accordance with claim 1, wherein the spacer element is a spacer plate that is positioned between two hinge pins of a chain link.

9. A plate-link chain in accordance with claim 1, wherein the chain links include at least one guide plate, wherein the at least one spacer plate is positioned between at least one of a guide plate and a fist link plate and between a guide plate and an opposed link plate.

10. A plate-link chain in accordance with claim 8, wherein a plurality of spacer plates are positioned within a chain link.

11. A plate-link chain in accordance with claim 8, wherein the spacer plate has a hinge pin covering contour in the running plane of the chain that is smaller than a hinge pin engagement contour of a first link plate and an opposed link plate.

12. A plate-link chain in accordance with claim 8, wherein the spacer plate has a hinge pin covering contour in the running plane of the chain that is larger in the region of the teeth of a first plate link and of an opposed plate than the covering contour area of the teeth of a first link plate and of an opposed link plate.

13. A plate-link chain in accordance with claim 8, wherein the spacer plate includes two receiving openings, each of which receives a hinge pin.

14. A plate-link chain in accordance with claim 8, wherein the spacer plate has a single receiving opening that receives a pair of hinge pins.

15. A plate-link chain in accordance with claim 13, wherein the spacer plate has two receiving openings, each with a gap to enable the spacer plate to be assembled to a hinge pin as a clip.

16. A plate-link chain in accordance with claim 15, wherein the gaps of the receiving openings are positioned on a side of the plate-link chain facing away from teeth formed on at least one of the link plates.

17. A spacer element for a plate-link chain, said spacer element comprising: a spacer plate having a predetermined thickness and at least one opening for engaging a hinge pin that interconnects adjacent link plates, wherein the spacer plate has a hinge pin covering contour in the running plane of the chain that is smaller than a hinge pin engagement contour of a link plate.
